(19) United States
(12) Patent Application Publication
(10) Pub. No.: US 2022/0124729 A1
(43) Pub. Date: Apr. 21, 2022

(54) SIDELINK RESOURCE SELECTION METHOD AND APPARATUS

(71) Applicant: FUJITSU LIMITED, Kawasaki-shi (JP)

(72) Inventors: Pengyu JI, Beijing (CN); Jian ZHANG, Beijing (CN); Lei ZHANG, Beijing (CN); Xin WANG, Beijing (CN)

(73) Assignee: FUJITSU LIMITED, Kawasaki-shi (JP)

(21) Appl. No.: 17/568,051

(22) Filed: Jan. 4, 2022

Related U.S. Application Data
(63) Continuation of application No. PCT/CN2019/097948, filed on Jul. 26, 2019.

(51) Int. Cl. H04W 72/10; H04W 72/04

(52) U.S. Cl. CPC H04W 72/10; H04W 72/0406

(57) ABSTRACT

A sidelink resource selection method and apparatus. The method includes: for a candidate resource set corresponding to a physical sidelink feedback channel, adjusting a priority of the candidate resource set by a terminal equipment at least according to a source terminal equipment and/or a destination terminal equipment of a reserved resource contained in the candidate resource set; and performing resource selection by the terminal equipment according to the priority to transmit sidelink data.

### CROSS-REFERENCE TO RELATED APPLICATION

This application is a continuation application of International Application PCT/CN2019/097948 filed on Jul. 26, 2019 and designated the U.S., the entire contents of which are incorporated herein by reference.

### TECHNICAL FIELD

This disclosure relates to the field of communication technologies.

### BACKGROUND

In vehicle to everything (V2X) communications of the long term evolution (LTE) system Rel-15 and previous release, broadcast services are only supported. After receiving packets transmitted by a terminal equipment as a transmitter (hereinafter referred to as a transmitting terminal equipment), a terminal equipment as a receiver (hereinafter referred to as a receiving terminal equipment) needs not to transmit feedback information (including ACK/NACK, which may be referred to as HARQ-ACK).

In new radio (NR) V2X, besides broadcast services, unicast services and groupcast services need also to be supported. In order to enhance reliabilities of these services, a sidelink (SL) feedback mechanism is introduced into NR V2X, that is, a receiving terminal equipment needs to feedback to a transmitting terminal equipment after receiving packets, contents that are fed back being dependent on a decoding result. Therefore, a physical sidelink feedback channel (PSFCH) is introduced into the sidelink for carrying feedback information of the sidelink.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY OF THE DISCLOSURE

It was found by the inventors that in the existing schemes, a case may possibly occur where a terminal equipment needs to simultaneously transmit and/or receive at least two PSFCHs which may collide (or referred to as conflict). If one of the PSFCHs is transmitted or received and the other(s) is(are) dropped, it will result in unnecessary retransmission and reliability of the retransmission will be affected, thereby affecting performance of the system.

Addressed to at least one of the above problems, embodiments of this disclosure provide a sidelink resource selection method and apparatus.

According to one aspect of the embodiments of this disclosure, there is provided a sidelink resource selection apparatus, including:

an adjusting unit configured to, for a candidate resource set corresponding to a physical sidelink feedback channel, adjust a resource selection threshold of the candidate resource set at least according to a source terminal equipment and/or a destination terminal equipment of a reserved resource contained in the candidate resource set; and

a selecting unit configured to perform resource selection according to the resource selection threshold to transmit sidelink data.

According to another aspect of the embodiments of this disclosure, there is provided a sidelink resource selection method, including:

for a candidate resource set corresponding to a physical sidelink feedback channel, adjusting a resource selection threshold of the candidate resource set by a terminal equipment at least according to a source terminal equipment and/or a destination terminal equipment of a reserved resource contained in the candidate resource set; and

performing resource selection by the terminal equipment according to the resource selection threshold to transmit sidelink data.

According to a further aspect of the embodiments of this disclosure, there is provided a communication system, including:

a terminal equipment configured to, for a candidate resource set corresponding to a physical sidelink feedback channel, adjust a resource selection threshold of the candidate resource set at least according to a source terminal equipment and/or a destination terminal equipment of a reserved resource contained in the candidate resource set, and perform resource selection according to the resource selection threshold to transmit sidelink data.

An advantage of the embodiments of this disclosure exists in that for a candidate resource set corresponding to a physical sidelink feedback channel, the terminal equipment adjusts a priority of the candidate resource set at least according to a source terminal equipment and/or a destination terminal equipment of a reserved resource contained in the candidate resource set. Thus, not only PSFCH collisions may be alleviated or even avoided, but also unnecessary retransmission may be reduced and reliability of retransmission may be improved.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of an embodiment of this disclosure;

FIG. 2 is a schematic diagram of a PSFCH resource of an embodiment of this disclosure;

FIG. 3 is an exemplary diagram of PSFCH collision of an embodiment of this disclosure;

FIG. 4 is another exemplary diagram of PSFCH collision of the embodiment of this disclosure;

FIG. 5 is a further exemplary diagram of PSFCH collision of the embodiment of this disclosure;

FIG. 6 is a schematic diagram of a sidelink resource selection method of an embodiment of this disclosure;

FIG. 7 is an exemplary diagram of lowering a resource priority of an embodiment of this disclosure;

FIG. 8 is another exemplary diagram of lowering a resource priority of the embodiment of this disclosure;

FIG. 9 is a schematic diagram of a sidelink resource selection apparatus of an embodiment of this disclosure;

FIG. 10 is a schematic diagram of a network device of an embodiment of this disclosure; and

FIG. 11 is a schematic diagram of a terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to an equipment in a communication system that accesses a terminal equipment to the communication network and provides services for the terminal equipment. The network device may include but not limited to the following equipment: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, which may be expressed as a serving cell, and may be a macro cell or a pico cell, depending on a context of the term.

In the embodiments of this disclosure, the term “user equipment (UE)” or “terminal equipment (TE) or terminal device” refers to, for example, equipment accessing to a communication network and receiving network services via a network device. The terminal equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station, and may include one or more network devices described above. The term “user side” or “terminal side” or “terminal equipment side” refers to a side of a user or a terminal, which may be a UE, and may include one or more terminal equipments described above.

Scenarios in the embodiments of this disclosure shall be described below by way of examples; however, this disclosure is not limited thereto.

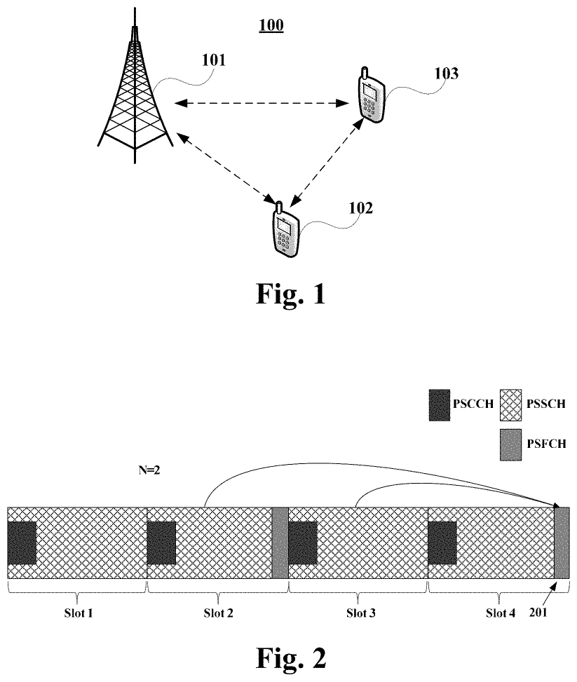

FIG. 1 is a schematic diagram of a communication system of an embodiment of this disclosure, in which a case where terminal equipments and a network device are taken as examples is schematically shown. As shown in FIG. 1, the communication system 100 may include a network device 101 and terminal equipments 102, 103. For the sake of simplicity, an example having only two terminal equipments and one network device is schematically given in FIG. 1; however, the embodiment of this disclosure is not limited thereto.

In the embodiment of this disclosure, existing services or services that may be implemented in the future may be performed between the network device 101 and the terminal equipments 102, 103. For example, such services may include but not limited to an enhanced mobile broadband (eMBB), massive machine type communication (MTC), and ultra-reliable and low-latency communication (URLLC), etc.

It should be noted that FIG. 1 shows that two terminal equipments 102, 103 are both within a coverage of the network device 101. However, this disclosure is not limited thereto, and the two terminal equipments 102, 103 may not be within the coverage of the network device 101, or one terminal equipment 102 is within the coverage of the network device 101 and the other terminal equipment 103 is outside the coverage of the network device 101.

In the embodiments of this disclosure, sidelink transmission may be performed between two terminal equipments 102, 103. For example, the two terminal equipments 102, 103 may both perform sidelink transmission within the coverage of the network device 101 to implement V2X communications, or both of them may perform sidelink transmission outside the coverage of the network device 101 to implement V2X communications, and it may also be that one terminal equipment 102 is within the coverage of the network device 101 and another terminal equipment 103 is outside the coverage of the network device 101 and perform sidelink transmission to implement V2X communications.

In the embodiments of this disclosure, the terminal equipments 102 and/or 103 may select a sidelink resource on its own (i.e. using mode 2), in which case the sidelink transmission may be independent of the network device 101, that is, the network device 101 is optional. In addition, selecting a sidelink resource by the terminal equipment on its own (i.e. using mode 2) and allocating a sidelink resource by the network device (i.e. using mode 1) may also be combined, and the embodiment of this disclosure is not limited thereto.

In the embodiments of this disclosure, at least a format that the PSFCH occupies last one or more symbols of a slot (following description shall be given by taking one symbol as an example) is supported, it is determined that a time interval between the PSFCH and a physical sidelink shared channel (PSSCH) in the time domain is semi-statically configured, an N-th slot in every N slots may include a PSFCH, N being an integer greater than or equal to 1, and the rest of the slots do not contain a PSFCH; each slot containing a PSFCH needs to feed back for a number of previous PSSCH transmissions. In the embodiments of this disclosure, it is assumed that the value is N, that is, N may be called a period of the PSFCH resource.

FIG. 2 is a schematic diagram of a PSFCH resource of an embodiment of this disclosure, exemplarily showing a relationship between a PSSCH and a PSFCH performing feedback thereon when the feedback period N=2. In FIG. 2, it is assumed that the receiving terminal equipment needs a time of a slot (such as slot 4 shown in FIG. 2) to demodulate and decode the PSSCH and generate feedback information (HARQ-ACK). Therefore, PSFCHs (such as two) on a symbol shown by 201 are fed back for a PSSCH of slot 2 and a PSSCH of slot 3, respectively.

Currently, there may exist a correspondence relationship between the PSFCH and the PSSCH with respect to resources. For example, a frequency domain resource (such as a sub-channel) to which the PSSCH corresponds may be used to determine a frequency-domain starting position of the PSFCH. In this way, after the PSSCH resource is selected, a corresponding PSFCH resource may also be determined, thus, the receiving terminal equipment does not need to perform resource sensing and selection for the PSFCH.

However, it may happen that the terminal equipment needs to simultaneously transmit and/or receive at least two PSFCHs which may collide.

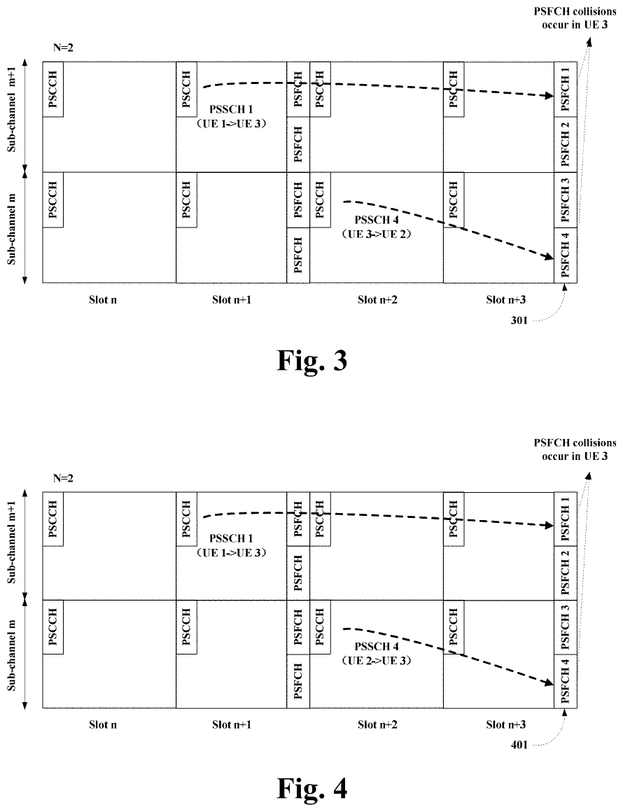

FIG. 3 is an exemplary diagram of PSFCH collision of an embodiment of this disclosure, showing a situation where the terminal equipment needs to simultaneously transmit and receive PSFCHs. As shown in FIG. 3, for example, N=2, PSFCH 1 and PSFCH 2 are on resources to which sub-channel m+1 and symbol 301 correspond, and PSFCH 1 performs feedback for PSSCH 1, wherein PSSCH 1 is transmitted by UE 1 to UE 3 on the resources to which sub-channel m+1 and slot n+1 correspond, and PSFCH 1 is transmitted by UE 3 to UE 1 on the resources to which sub-channel m+1 and symbol 301 correspond.

As shown in FIG. 3, PSFCH 3 and PSFCH 4 are on resources to which sub-channel m and symbol 301 correspond, and PSFCH 4 performs feedback for PSSCH 4, wherein PSSCH 4 is transmitted by UE 3 to UE 2 on the resources to which sub-channel m and slot n+2 correspond, and PSFCH 4 is transmitted by UE 2 to UE 3 on the resources to which sub-channel m and symbol 301 correspond.

That is, within a time period in which the PSFCH in symbol 301 is responsible for feeding back for the PSSCH (slots n+1 and n+2), UE 3 needs to be taken as a source UE for at least one time of transmission (PSSCH 4) and as a destination UE for at least one time of transmission (PSSCH 1). UE 3 needs to simultaneously receive and transmit PSFCHs in a symbol containing a PSFCH (i.e. symbol 301) (i.e. receive PSFCH 4 and transmit PSFCH 1); however, due to a half-duplex setting of a V2X UE, UE 3 is only able to complete one of reception or transmission, and is unable to perform reception and transmission simultaneously.

FIG. 4 is another exemplary diagram of PSFCH collision of the embodiment of this disclosure, showing a situation where a terminal equipment needs to transmit two PSFCHs to other two terminal equipments simultaneously. As shown in FIG. 4, for example, N=2, PSFCH 1 and PSFCH 2 are on resources to which sub-channel m+1 and symbol 401 correspond, and PSFCH 1 performs feedback for PSSCH 1, wherein PSSCH 1 is transmitted by UE 1 to UE 3 on the resources to which sub-channel m+1 and slot n+1 correspond, and PSFCH 1 is transmitted by UE 3 to UE 1 on the resources to which sub-channel m+1 and symbol 401 correspond.

As shown in FIG. 4, PSFCH 3 and PSFCH 4 are on resources to which sub-channel m and symbol 401 correspond, and PSFCH 4 performs feedback for PSSCH 4, wherein PSSCH 4 should be transmitted by UE 2 to UE 3 on the resources to which sub-channel m and slot n+2 correspond, and PSFCH 4 is transmitted by UE 3 to UE 2 on the resources to which sub-channel m and symbol 401 correspond.

That is, within a time period in which the PSFCH in symbol 401 is responsible for feeding back for the PSSCH (slots n+1 and n+2), UE 3 needs to be taken as a destination UE for at least two transmissions (PSSCH 1 and PSSCH 4), and source UEs for the at least two transmissions are different. UE 3 needs to simultaneously transmit two PSFCHs in a symbol containing PSFCHs (i.e. symbol 401) (i.e. transmit PSFCH 4 and transmit PSFCH 1); however, as a V2X UE is unable to transmit two PSFCHs simultaneously, UE 3 is only able to complete transmission of one of the two PSFCHs.

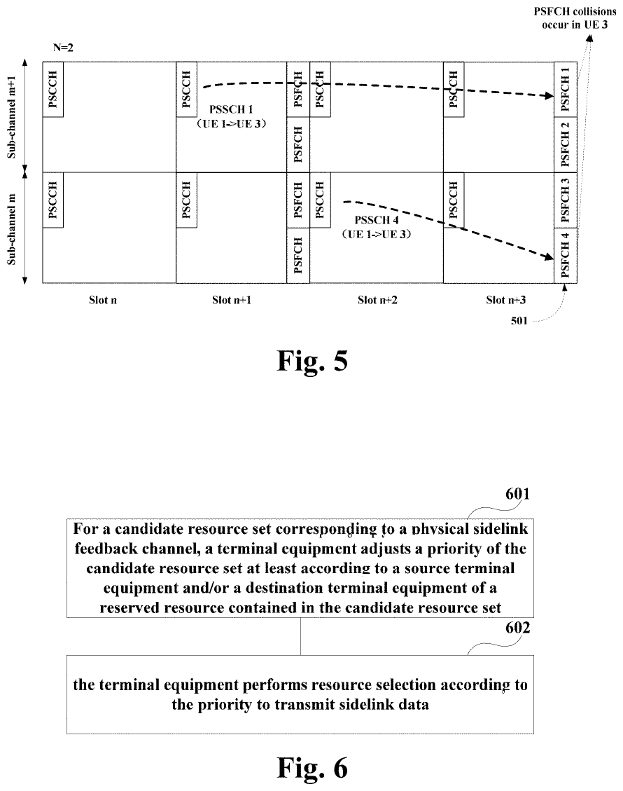

FIG. 5 is a further exemplary diagram of PSFCH collision of the embodiment of this disclosure, showing a situation where a terminal equipment needs to transmit two PSFCHs to another terminal equipment simultaneously. As shown in FIG. 5, for example, N=2, PSFCH 1 and PSFCH 2 are on resources to which sub-channel m+1 and symbol 501 correspond, and PSFCH 1 performs feedback for PSSCH 1, wherein PSSCH 1 is transmitted by UE 1 to UE 3 on the resources to which sub-channel m+1 and slot n+1 correspond, and PSFCH 1 is transmitted by UE 3 to UE 1 on the resources to which sub-channel m+1 and symbol 501 correspond.

As shown in FIG. 5, PSFCH 3 and PSFCH 4 are on resources to which sub-channel m and symbol 501 correspond, and PSFCH 4 performs feedback for PSSCH 4, wherein PSSCH 4 should be transmitted by UE 1 to UE 3 on the resources to which sub-channel m and slot n+2 correspond, and PSFCH 4 is transmitted by UE 3 to UE 1 on the resources to which sub-channel m and symbol 501 correspond.

That is, within a time period in which the PSFCH in symbol 501 is responsible for feeding back for the PSSCH (slots n+1 and n+2), UE 3 needs to be taken as a destination UE for at least two transmissions (PSSCH 1 and PSSCH 4), and source UEs for the at least two transmissions are identical. UE 3 needs to simultaneously transmit two PSFCHs in a symbol containing PSFCHs (i.e. symbol 501) (i.e. transmit PSFCH 4 and transmit PSFCH 1); however, as a V2X UE is unable to transmit two PSFCHs simultaneously, UE 3 is only able to complete transmission of one of the two PSFCHs.

When collision occurs in the above PSFCHs, according to priorities of the at least two transmissions, a decoding result (ACK or NACK) and such information as the number of bits needing to be fed back, etc., only one PSFCH thereof is transmitted or received while the other PSFCHs may be discarded. However, frequently discarding HARQ-ACKs may affect reliability of retransmission and cause unnecessary retransmissions, thereby affecting system performance.

In the embodiments of this disclosure, the sidelink PSFCHs are described by taking V2X as an example; however, this disclosure is not limited thereto, and it may also be applicable to sidelink transmission scenarios other than V2X. In the following description, without causing confusion, the terms “sidelink” and “V2X” may be interchangeable, the terms “PSFCH” and “sidelink feedback channel” may be interchangeable, and the terms “PSSCH” and “sidelink data channel” or “sidelink data” may also be interchangeable.

In the embodiments of this disclosure, sidelink control information (SCI) is carried by a physical sidelink control channel (PSCCH), sidelink data are carried by a PSSCH, and sidelink feedback information is carried by a PSFCH.

In addition, transmitting or receiving a PSSCH may be construed as transmitting or receiving sidelink data carried by the PSSCH; and transmitting or receiving a PSFCH may be construed as transmitting or receiving sidelink feedback information carried by the PSFCH. At least one time of transmission may be construed as at least one PSSCH transmission or at least one sidelink data transmission, and current transmission may be construed as current PSSCH transmission or current sidelink data transmission.

### Embodiments of the First Aspect

The embodiments of this disclosure provide a sidelink resource selection method, which shall be described from a side of a first terminal equipment. The first terminal equipment serves as a transmitter and transmits sidelink data to a second terminal equipment; and the first terminal equipment serves as a receiver and receives sidelink feedback information transmitted by the second terminal equipment.

FIG. 6 is a schematic diagram of the sidelink resource selection method of the embodiment of this disclosure. As shown in FIG. 6, the method includes:

601: for a candidate resource set corresponding to a physical sidelink feedback channel, a terminal equipment adjusts a priority of the candidate resource set at least according to a source terminal equipment and/or a destination terminal equipment of a reserved resource contained in the candidate resource set; and

602: the terminal equipment performs resource selection according to the priority to transmit sidelink data.

It should be noted that FIG. 6 only schematically illustrates the embodiment of this disclosure; however, this disclosure is not limited thereto. For example, an order of execution of the operations may be appropriately adjusted, and furthermore, some other operations may be added, or some operations therein may be reduced. And appropriate variants may be made by those skilled in the art according to the above contents, without being limited to what is contained in FIG. 6.

In the embodiments of this disclosure, the same PSFCH corresponds to one candidate resource set. In a resource selection process when sidelink data are transmitted, the terminal equipment selects a transmit resource from the candidate resource set. A reserved candidate resource (referred to as reserved resource for short) corresponds to a resource selection threshold. Specifically, the resource selection threshold is, for example, a reference signal received power (RSRP) value of a last transmitted signal which reserved the candidate resource, the signal may be a PSSCH or a PSCCH, and the RSRP value may be reference signal power of the PSSCH or PSCCH.

By changing the resource selection threshold, a priority of the candidate resource set (or also referred to as a priority of a resource in the candidate resource set) may be adjusted; for example, priorities of all resources in the candidate resource set may be lowered. Regarding the resource sensing (or detection) and resource selection process, reference may be made to related technologies for specific contents of the candidate resource set and resource selection threshold, such as the contents in subsection 14.1.1.6 in 3GPP TS 36.213 V15.2.0.

In the embodiments of this disclosure, the reserved resource is a resource detected by the terminal equipment and indicated by other terminal equipment to reserve in sidelink control information (SCI), that is, the SCI may indicate the resource transmitted this time and a resource reserved for next time of transmission. In the resource sensing process, the terminal equipment may learn a source terminal equipment and a destination terminal equipment of the reserved resource by detecting the SCI.

Therefore, by adjusting the priority of the candidate resource set by the source terminal equipment and/or the destination terminal equipment of the reserved resource, the terminal equipment may be enabled to avoid PSSCH resources where PSFCH collision may occur in the resource selection process. PSFCH collision may be avoided or a possibility of PSFCH collision may be reduced, and system performance of feedback-based retransmission mechanism may be improved.

In some embodiments, a service type of at least one time of transmission to which the reserved resource corresponds is of a unicast service or a groupcast service, and feedback of the at least one time of transmission is enabled. For example, a resource pool of the transmission is configured with a PSFCH, and a feedback function thereof is preconfigured as being ON or is configured as being ON (such as via RRC signaling) or is indicated to be ON (such as via DCI). Alternatively, a priority of the at least one time of transmission of the reserved resources is lower than a priority of current transmission, for example, a PPPP value of the at least one time of transmission is greater than a PPPP value of the current transmission.

This disclosure shall be schematically described below with respect to a case where the terminal equipment shown in FIG. 4 needs to simultaneously transmit two PSFCHs to other two terminal equipments, wherein the source terminal equipment of the at least one time of transmission of the reserved resource is different from a source terminal equipment of the current transmission.

In some embodiments, the terminal equipment determines whether the destination terminal equipment of the at least one time of transmission of the reserved resource is identical to the destination terminal equipment of the current transmission or a destination terminal equipment in a destination terminal equipment group of the current transmission, and lowers priorities of the resources in the candidate resource set in a case where the destination terminal equipment of the at least one time of transmission of the reserved resource is identical to the destination terminal equipment of the current transmission or a destination terminal equipment in the destination terminal equipment group of the current transmission.

For example, if the following first group of conditions is satisfied, the priorities of the resources in the candidate resource set are lowered.

### THE FIRST GROUP OF CONDITIONS

Condition 1: the candidate resource set containing some resources reserved by other UEs (including those that are periodically reserved and non-periodically reserved);

Condition 2: in one or more times of transmissions of the reserved resources, at least one time of transmission satisfying the following conditions:

the at least one time of transmission being of unicast or groupcast, and the HARQ-ACK feedback function being enabled;

the at least one time of transmission and the current transmission have identical destination terminal equipments (what is currently transmitted is a unicast service, and a destination ID of the at least one time of transmission of the reserved resource is identical to a destination ID of the current transmission), or a destination terminal equipment group ID of the current transmission includes the destination terminal equipment of the at least one time of transmission (what is currently transmitted is a groupcast service, and the destination ID of the at least one time of transmission of the reserved resource is included in a destination group of the current transmission), that is, a destination UE of the transmission of the reserved resource is a destination UE of the current transmission;

optionally, the priority of the at least one time of transmission is greater than the priority of the current transmission, or the PPPP value of the at least one time of transmission is lower than the PPPP value of current transmission.

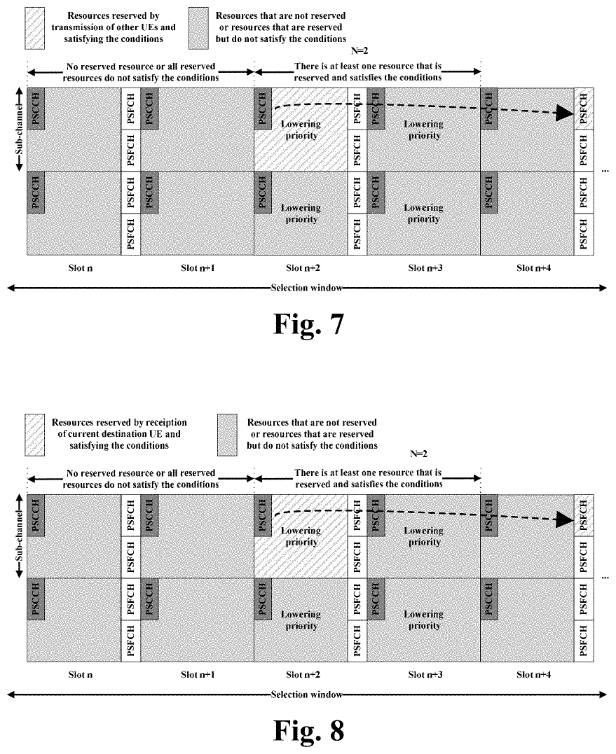

FIG. 7 is an exemplary diagram of lowering a resource priority of the embodiment of this disclosure. As shown in FIG. 7, for example, N=2, no reserved resource is at a slot n and a slot n+1, or a reserved resource at a slot n and a slot n+1 does not satisfy the above conditions, and at least one reserved resource at a slot n+2 and a slot n+3 satisfies the above conditions; for example, the resource is reserved by transmission of another UE and satisfies the above conditions, and priorities of all resources in a corresponding candidate resource set are lowered.

In some embodiments, the current transmission is of an aperiodic service, and a PSFCH resource to which the reserved resource corresponds and a PSFCH resource to which the aperiodic service corresponds at least partially overlap in the time domain. For example, the two PSFCHs occupy identical one or more symbols. Frequency domain positions of the PSFCH resources are not limited in this disclosure.

In some embodiments, the current service is of a periodic service, and the PSFCH resource to which the reserved resource corresponds and a PSFCH resource to which an M-th transmission of the periodic service corresponds at least partially overlap in the time domain, M being a positive integer greater than or equal to 1. For example, the two PSFCHs occupy identical one or more symbols. Frequency domain positions of the PSFCH resources are not limited in this disclosure.

For example, the candidate resource set may be lowered with respect to the priority when the above conditions are satisfied in a selection window of a transmission of aperiodic services and a first time of transmission of periodic services by the UE, and for condition 1, it may also be resources reserved by the service for a next time of transmission and resources reserved by a current service (if it is periodic) for a next time (or an M-th time) of transmission, for feedback of which PSFCHs of identical symbols are responsible, and condition 2 is satisfied. And at this moment, a priority of a current candidate resource set is also lowered.

In some embodiments, the lowering priorities of the resources in the candidate resource set includes: reducing a resource selection threshold in the candidate resource set to be infinitesimal, that is, excluding the resources in the candidate resource set completely; or reducing a resource selection threshold to a minimum allowable value.

In some embodiments, the lowering priorities of the resources in the candidate resource set includes: reducing a resource selection threshold in the candidate resource set by a first value. For example, an RSRP value of a PSSCH or PSCCH of a last time of transmission of the reserved candidate resource is reduced by 3 dB and is taken as a resource selection threshold for resource selection of the current transmission.

The RSRP value may be a value to which priorities of a service of the current transmission and a detected reserved service correspond. For example, the RSRP value may be determined by I*a+b+1, where, I is a constant (such as 8), a is the priority of the service of the current transmission, and b is the priority of the service of the detected reserved resource; and on this basis, it is further reduced by 3 dB; however, this disclosure is not limited thereto.

In some embodiments, a size of the first value is determined at least according to the number of reserved resources in the candidate resource set satisfying the conditions, that is, the size of the first value is related to the number of reserved resources in the candidate resource set satisfying the conditions. In addition, for multiple transmissions of reserved resources detected in one PSFCH period, thresholds thereof may be different.

For example, if there are multiple resources or resource subsets in a candidate resource set satisfying the above conditions, the threshold may be further lowered. For example, if the number of resources satisfying the conditions is 1, RSRP values of multiple transmissions of reserved resources detected in a PSFCH period may be reduced by 3 dB respectively; if the number of resources satisfying the conditions is 2, RSRP values of multiple transmissions of reserved resources detected in a PSFCH period may be reduced by 4 dB respectively, and if the number of resources satisfying the conditions is 3, RSRP values of multiple transmissions of reserved resources detected in a PSFCH period may be reduced by 5 dB respectively, . . . ;

or, if the number of resources satisfying the conditions reaches s, RSRP values of multiple transmissions of reserved resources detected in a PSFCH period may be reduced by 3 dB respectively, if the number of resources satisfying the conditions reaches j, RSRP values of multiple transmissions of reserved resources detected in a PSFCH period may be reduced by 6 dB respectively, and if the number of resources satisfying the conditions reaches k, RSRP values of multiple transmissions of reserved resources detected in a PSFCH period may be reduced by 9 dB respectively, . . . .

In some embodiments, when the terminal equipment selects candidate resources, it preferentially selects resources from unreserved resources, then selects resources from reserved resources unsatisfying the conditions, and finally selects resources from reserved resources satisfying the conditions.

For example, in a resource selection candidate set, it first fills the unreserved resources, then fills the reserved resources unsatisfying the conditions, and finally fills reserved resources satisfying the conditions, until 20% of resources in the selection window are satisfied. In a group formed by each type of resources, resource priorities are sorted by using an S-RSSI.

This disclosure shall be schematically described below with respect to a case where the terminal equipment shown in FIG. 5 needs to simultaneously transmit two PSFCHs to other two terminal equipments, wherein the source terminal equipment of the at least one time of transmission of the reserved resource is identical to the source terminal equipment of the current transmission.

In some embodiments, the terminal equipment determines whether the number of bits of the physical sidelink feedback channel exceeds a maximum value that is able to be carried by the physical sidelink feedback channel, and in a case where the destination terminal equipment of the at least one time of transmission of the reserved resource is identical to the destination terminal equipment of the current transmission or the destination terminal equipment in a destination terminal equipment group of the current transmission and the number of bits of the physical sidelink feedback channel exceeds the maximum value that is able to be carried by the physical sidelink feedback channel, lowers the priorities of the resources in the candidate resource set.

For example, for the case in FIG. 5, the terminal equipment may first determine whether the number of bits of the PSFCH exceeds a maximum value that the PSFCH may carry. If the number of bits does not exceed the maximum value, UE 3 may cascade two pieces of feedback information (HARQ-ACK) to a PSFCH and transmit the information to UE 1. And if the number of bits exceeds the maximum value, UE 1 determines whether the above conditions are satisfied in the resource selection process, and if the conditions are satisfied, the priorities of the resources in the candidate resource set are lowered.

This disclosure shall be schematically described below with respect to a case where the terminal equipment shown in FIG. 3 needs to simultaneously transmit and receive PSFCHs.

In some embodiments, the terminal equipment determines whether the destination terminal equipment of at least one time of transmission of the reserved resource is identical to the source terminal equipment of the current transmission, and lowers the priorities of the resources in the candidate resource set in a case where the destination terminal equipment of the at least one time of transmission of the reserved resource is identical to the source terminal equipment of the current transmission.

For example, if the following second group of conditions is satisfied, the priorities of the resources in the candidate resource set are lowered.

### THE SECOND GROUP OF CONDITIONS

Condition 3: the candidate resource set contains some resources reserved by another UE (including periodically reserved resources and non-periodically reserved resources);

Condition 4: in one or more times of transmissions of the reserved resources, at least one time of transmission satisfies the following conditions:

the at least one time of transmission is of unicast or groupcast, and the HARQ-ACK feedback function is enabled;

the destination terminal equipment of the at least one time of transmission and the source terminal equipment of the current transmission are identical (the current transmission is of a unicast service or a groupcast service, and a destination ID of the at least one time of transmission of the reserved resource is identical to a source ID of the current transmission), that is, a destination UE of the transmission of the reserved resources is a source UE of the current transmission; and

optionally, the priority of the at least one time of transmission is greater than the priority of the current transmission, or the PPPP value of the at least one time of transmission is lower than the PPPP value of the current transmission.

FIG. 8 is another exemplary diagram of lowering a resource priority of the embodiment of this disclosure. As shown in FIG. 8, for example, N=2, no reserved resource is at a slot n and a slot n+1, or a reserved resource does not satisfy the above conditions, and at least one reserved resource at a slot n+2 and a slot n+3 satisfies the above conditions; for example, the resource is reserved by reception of a current destination UE and satisfies the conditions, and priorities of all resources in a corresponding candidate resource set are lowered.

In some embodiments, the current transmission is of an aperiodic service, and a PSFCH resource to which the reserved resource corresponds and a PSFCH resource to which the aperiodic service corresponds at least partially overlap in the time domain, or the current transmission is of a periodic service, and a PSFCH resource to which the reserved resource corresponds and a PSFCH resource to which an M-th time of transmission of the periodic service corresponds at least partially overlap in the time domain, M being a positive integer greater than or equal to 1.

For example, the candidate resource set may be lowered with respect to the priority when the above conditions are satisfied in a selection window of a transmission of aperiodic services and a first time of transmission of periodic services by the UE, and for condition 3, it may also be resources reserved by the service for a next time of transmission and resources reserved by a current service (if it is periodic) for a next time (or an M-th time) of transmission, for feedback of which PSFCHs of identical symbols are responsible, and condition 4 is satisfied. And at this moment, the priority of the current candidate resource set is also lowered.

In some embodiments, the lowering priorities of the resources in the candidate resource set includes: reducing a resource selection threshold in the candidate resource set to be infinitesimal, that is, excluding the resources in the candidate resource set completely; or reducing a resource selection threshold to a minimum allowable value.

In some embodiments, the lowering priorities of the resources in the candidate resource set includes: reducing a resource selection threshold in the candidate resource set by a second value. For example, an RSRP value of a PSSCH or PSCCH of a last time of transmission of the reserved candidate resource is reduced by 3 dB and is taken as a resource selection threshold for resource selection of the current transmission.

The RSRP value may be a value to which priorities of a service of the current transmission and a detected reserved service correspond. For example, the RSRP value may be determined by I*a+b +1, where, I is a constant (such as 8), a is the priority of the service of the current transmission, and b is the priority of the service of the detected reserved resource; and on this basis, it is further reduced by 3 dB; however, this disclosure is not limited thereto.

In some embodiments, a size of the second value is determined at least according to the number of reserved resources in the candidate resource set satisfying the conditions, that is, the size of the second value is related to the number of reserved resources in the candidate resource set satisfying the conditions. In addition, for multiple transmissions of reserved resources detected in one PSFCH period, thresholds thereof may be different.

For example, if there are multiple resources or resource subsets in a candidate resource set satisfying the above conditions, the threshold may be further lowered. For example, if the number of resources satisfying the conditions is 1, RSRP values of multiple transmissions of reserved resources detected in a PSFCH period may be reduced by 3 dB respectively; if the number of resources satisfying the conditions is 2, RSRP values of multiple transmissions of reserved resources detected in a PSFCH period may be reduced by 4 dB respectively, and if the number of resources satisfying the conditions is 3, RSRP values of multiple transmissions of reserved resources detected in a PSFCH period may be reduced by 5 dB respectively, . . . ;

or, if the number of resources satisfying the conditions reaches s, RSRP values of multiple transmissions of reserved resources detected in a PSFCH period may be reduced by 3 dB respectively, if the number of resources satisfying the conditions reaches j, RSRP values of multiple transmissions of reserved resources detected in a PSFCH period may be reduced by 6 dB respectively, and if the number of resources satisfying the conditions reaches k, RSRP values of multiple transmissions of reserved resources detected in a PSFCH period may be reduced by 9 dB respectively, . . . .

In some embodiments, when the terminal equipment selects candidate resources, it preferentially selects candidate resources from unreserved resources, then selects candidate resources from reserved resources unsatisfying the conditions, and finally selects candidate resources from reserved resources satisfying the conditions.

For example, in a resource selection candidate set, it first fills the unreserved resources, then fills the reserved resources unsatisfying the conditions, and finally fills reserved resources satisfying the conditions, until 20% of resources in the selection window are satisfied. In a group formed by each type of resources, resource priorities are sorted by using an S-RSSI.

In some embodiments, the terminal equipment determines whether the source terminal equipment of the at least one time of transmission of the reserved resource is identical to a destination terminal equipment of the current transmission or a destination terminal equipment in a group of destination terminal equipments of the current transmission, and lowers priorities of the resources in the candidate resource set in a case where the source terminal equipment of the at least one time of transmission of the reserved resource is identical to the destination terminal equipment of the current transmission or a destination terminal equipment in the destination terminal equipment group of the current transmission.

For example, if the following third group of conditions is satisfied, the priorities of the resources in the candidate resource set are lowered.

### THE THIRD GROUP OF CONDITIONS

Condition 5: the candidate resource set containing some resources reserved by other UEs (including those that are periodically reserved and non-periodically reserved);

Condition 6: in one or more times of transmissions of the reserved resources, at least one time of transmission satisfies the following conditions:

the at least one time of transmission is of unicast or groupcast, and the HARQ-ACK feedback function is enabled;

the source terminal equipment of the at least one time of transmission and the destination terminal equipment of the current transmission are identical (the current transmission is of a unicast service, and a source ID of the at least one time of transmission of the reserved resource is identical to a destination ID of the current transmission), or a destination terminal equipment group ID of the current transmission includes a source terminal equipment of the at least one time of transmission (what is currently transmitted is a groupcast service, and the source ID of the at least one time of transmission of the reserved resource is contained in the destination group of the current transmission), that is, the source UE of the transmission of the reserved resource is the destination UE of the current transmission; and

optionally, the priority of the at least one time of transmission is greater than the priority of the current transmission, or the PPPP value of the at least one time of transmission is lower than the PPPP value of the current transmission.

In some embodiments, the current transmission is of an aperiodic service, and a PSFCH resource to which the reserved resource corresponds and a PSFCH resource to which the aperiodic service corresponds at least partially overlap in the time domain, or the current transmission is of a periodic service, and a PSFCH resource to which the reserved resource corresponds and a PSFCH resource to which an M-th time of transmission of the periodic service corresponds at least partially overlap in the time domain, M being a positive integer greater than or equal to 1.

For example, the candidate resource set may be lowered with respect to the priority when the above conditions are satisfied in a selection window of a transmission of aperiodic services and a first time of transmission of periodic services by the UE, and for condition 5, it may also be resources reserved by the service for a next time of transmission and resources reserved by a current service (if it is periodic) for a next time (or an M-th time) of transmission, for feedback of which PSFCHs of identical symbols are responsible, and condition 6 is satisfied. And at this moment, the priority of the current candidate resource set is also lowered.

In some embodiments, lowering the priority of the resources in the candidate resource set includes: reducing the resource selection threshold in the candidate resource set to be infinitesimal, that is, completely excluding the resources in the candidate resource set; or reducing a resource selection threshold to a minimum allowable value.

In some embodiments, the lowering priorities of the resources in the candidate resource set includes: reducing a resource selection threshold in the candidate resource set by a third value. For example, an RSRP value of a PSSCH or PSCCH of a last time of transmission of the reserved candidate resource is reduced by 3 dB and is taken as a resource selection threshold for resource selection of the current transmission.

The RSRP value may be a value to which priorities of a service of the current transmission and a detected reserved service correspond. For example, the RSRP value may be determined by I*a+b+1, where, I is a constant (such as 8), a is the priority of the service of the current transmission, and b is the priority of the service of the detected reserved resource; and on this basis, it is further reduced by 3 dB; however, this disclosure is not limited thereto.

In some embodiments, a size of the third value is determined at least according to the number of reserved resources in the candidate resource set satisfying the conditions, that is, the size of the third value is related to the number of reserved resources in the candidate resource set satisfying the conditions. In addition, for multiple transmissions of reserved resources detected in one PSFCH period, thresholds thereof may be different.

For example, if there are multiple resources or resource subsets in a candidate resource set satisfying the above conditions, the threshold may be further lowered. For example, if the number of resources satisfying the conditions is 1, RSRP values of multiple transmissions of reserved resources detected in a PSFCH period may be reduced by 3 dB respectively; if the number of resources satisfying the conditions is 2, RSRP values of multiple transmissions of reserved resources detected in a PSFCH period may be reduced by 4 dB respectively, and if the number of resources satisfying the conditions is 3, RSRP values of multiple transmissions of reserved resources detected in a PSFCH period may be reduced by 5 dB respectively, . . . ;

or, if the number of resources satisfying the conditions reaches s, RSRP values of multiple transmissions of reserved resources detected in a PSFCH period may be reduced by 3 dB respectively, if the number of resources satisfying the conditions reaches j, RSRP values of multiple transmissions of reserved resources detected in a PSFCH period may be reduced by 6 dB respectively, and if the number of resources satisfying the conditions reaches k, RSRP values of multiple transmissions of reserved resources detected in a PSFCH period may be reduced by 9 dB respectively, . . . .

In some embodiments, when the terminal equipment selects candidate resources, it preferentially selects resources from unreserved resources, then selects resources from reserved resources unsatisfying the conditions, and finally selects resources from reserved resources satisfying the conditions.

For example, in a resource selection candidate set, it first fills the unreserved resources, then fills the reserved resources unsatisfying the conditions, and finally fills reserved resources satisfying the conditions, until 20% of resources in the selection window are satisfied. In a group formed by each type of resources, resource priorities are sorted by using an S-RSSI.

The above description is given by taking the first to third groups of conditions as examples. The above three groups of conditions may also be used in a combination of two, or the three groups of conditions may be used in a combination three; however, this disclosure is not limited thereto, and other condition groups may also be set as actually demanded.

In some embodiments, the terminal equipment determines whether the following at least two conditions are satisfied that: the destination terminal equipment of the at least one time of transmission of the reserved resources is identical to the destination terminal equipment of the current transmission or a destination terminal equipment in the destination terminal equipment group of the current transmission, the destination terminal equipment of the at least one time of transmission of the reserved resources is identical to the source terminal equipment of the current transmission, and the source terminal equipment of at least one time of transmission of the reserved resources is identical to the destination terminal equipment of the current transmission or a destination terminal equipment in the destination terminal equipment group of the current transmission; and when at least two conditions are satisfied, the priorities of the resources in the candidate resource set are lowered. For example, the resource selection threshold in the candidate resource set is reduced by a fourth value.

The above first value, second value, third value and fourth value may be different from each other, or at least two of them may be identical. For example, the first value to which the first group of conditions corresponds is 3 dB, the second value to which the second group of conditions corresponds is 4 dB, and the third value to which the third group of conditions corresponds is 5 dB; or, a resource selection threshold (the fourth value) to which a combination of the first group of conditions and the second group of conditions corresponds is 3.5 dB, and a resource selection threshold (the fourth value) to which a combination of the second group of conditions and the third group of conditions corresponds is 4.5 dB, and this disclosure is not limited thereto.

In some embodiments, when there are multiple resources or resource subsets in the candidate resource set that satisfy the conditions, they may be divided into multiple groups resources according to the conditions (for example, resources satisfying the three groups of conditions may be divided into three groups), and priorities of the multiple groups of resources may be calculated separately or jointly.

In some embodiments, if PSFCH collision still occurs after the embodiment of this disclosure is implemented (that is, after lowering the priority of the candidate resource set), the terminal equipment may only transmit or receive one PSFCH and discard other PSFCHs.

For example, if the situation shown in FIG. 3 where UE 3 needs to simultaneously transmit and receive PSFCH still occurs after lowering the priorities of the resources in this disclosure is implemented, UE 3 may discard one of the PSFCHs; for example, UE 3 only receives PSFCH 4, but does not feed PSFCH 1 back to UE 1.

For another example, if the situation shown in FIG. 4 where UE 3 needs to simultaneously transmit PSFCHs to UE 1 and UE 2 still occurs after lowering the priorities of the resources in this disclosure is implemented, UE 3 may discard one of the PSFCHs; for example, UE 3 only feeds PSFCH 4 to UE2, but does not feed PSFCH 1 back to UE 1.

For a further example, if the situation shown in FIG. 5 where UE 3 needs to simultaneously transmit two PSFCHs to UE 1 still occurs after lowering the priorities of the resources in this disclosure is implemented, UE 3 may discard one of the PSFCHs; for example, UE 3 only feeds PSFCH 4 to UE 1, but does not feed PSFCH 1 back to UE 1.

The case where the at least one time of transmission of the reserved resources is of a unicast service is described above, and at least one time of transmission of reserved resources may also be of a groupcast service. The terminal equipment may not be able to determine whether the destination group of the groupcast of the reserved resources contains the destination UE of the current transmission, in which case the terminal equipment may not perform priority reduction; or it may lower the resource selection threshold of the candidate resource set by default in a case where it is detected that the reserved resources are used for groupcast and the UE in the destination group is invisible to the terminal equipment.

In some embodiments, the terminal equipment detects whether the destination terminal equipment in the destination terminal equipment group of the at least one time of transmission of the reserved resources is invisible, or the terminal equipment is not sure whether the destination terminal equipment in the destination terminal equipment group of the at least one time of transmission of the reserved resources is visible; and lowers the priorities of the resources in the candidate resource set in a case where the destination terminal equipment in the destination terminal equipment group of the at least one time of transmission of the reserved resources is invisible or whether is it visible is not sure.

For example, the terminal equipment may lower the resource selection threshold of the candidate resource set by a fifth value (for example, 3 dB).

In some embodiments, when the one or more destination terminal equipments in the destination terminal equipment group of the at least one time of transmission of the reserved resources is/are invisible, the terminal equipment determines whether one of the following conditions or a combination thereof is satisfied: a destination terminal equipment of the at least one time of transmission of the reserved resources is identical to the destination terminal equipment of the current transmission or a destination terminal equipment in the destination terminal equipment group of the current transmission, a destination terminal equipment of the at least one time of transmission of the reserved resource is identical to the source terminal equipment of the current transmission, and a source terminal equipment of the at least one time of transmission of the reserved resource is identical to the destination terminal equipment of the current transmission or a destination terminal equipment in the destination terminal equipment group of the current transmission; and lowers the resource selection threshold in the candidate resource set when one of the above conditions or a combination thereof is satisfied.

For example, the terminal equipment may lower the resource selection threshold of the candidate resource set by a sixth value (such as 3 dB).

In some embodiments, any two of the first to sixth values may be different from each other, or at least two of the first to sixth values are identical; and specific values may be determined as actually demanded or according to empirical values.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It can be seen from the above embodiments that for a candidate resource set corresponding to a physical sidelink feedback channel, the terminal equipment adjusts a priority of the candidate resource set at least according to a source terminal equipment and/or a destination terminal equipment of a reserved resource contained in the candidate resource set. Thus, not only PSFCH collisions may be alleviated or even avoided, but also unnecessary retransmission may be reduced and reliability of retransmission may be improved.

### Embodiments of the Second Aspect

The embodiments of this disclosure provide a sidelink resource selection apparatus. The apparatus may be, for example, a terminal equipment, or may be one or more components or assemblies configured in a terminal equipment. Contents in the embodiments identical to those in the embodiments of the first aspect shall not be described herein any further.

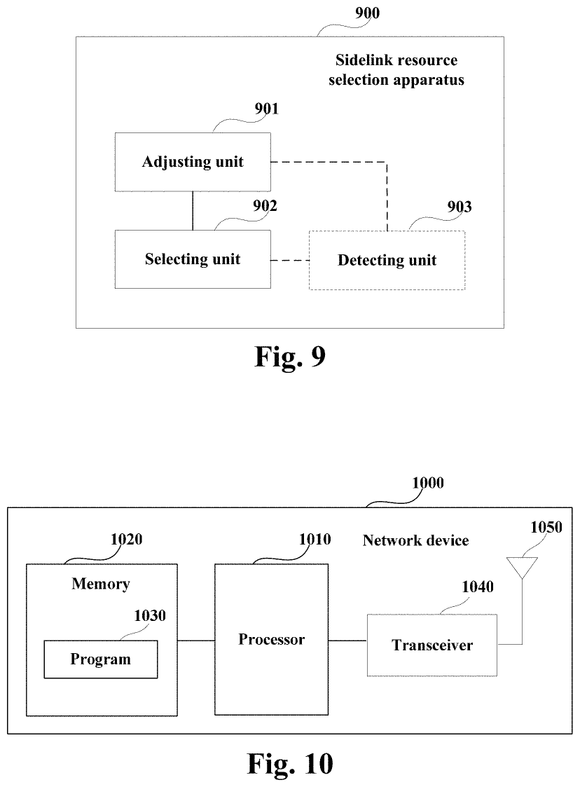

FIG. 9 is a schematic diagram of the sidelink resource selection apparatus of the embodiment of this disclosure. As shown in FIG. 9, the sidelink resource selection apparatus 900 includes:

an adjusting unit 901 configured to, for a candidate resource set corresponding to a physical sidelink feedback channel, adjust a priority of the candidate resource set at least according to a source terminal equipment and/or a destination terminal equipment of a reserved resource contained in the candidate resource set; and

a selecting unit 902 configured to perform resource selection according to the priority to transmit sidelink data.

In some embodiments, a service type of at least one time of transmission to which the reserved resource corresponds is of a unicast service or a groupcast service, and feedback of the at least one time of transmission is enabled.

In some embodiments, a priority of the at least one time of transmission of the reserved resources is lower than a priority of current transmission.

In some embodiments, the reserved resource is a resource detected by a terminal equipment and indicated by other terminal equipments to be reserved via sidelink control information.

In some embodiments, the adjusting unit 901 is configured to: determine whether a destination terminal equipment of at least one time of transmission of the reserved resource is identical to a destination terminal equipment of the current transmission or a destination terminal equipment in a destination terminal equipment group of the current transmission, and lower priorities of the resources in the candidate resource set in a case where the destination terminal equipment of the at least one time of transmission of the reserved resource is identical to the destination terminal equipment of the current transmission or a destination terminal equipment in the destination terminal equipment group of the current transmission.

In some embodiments, the adjusting unit 901 reduces a resource selection threshold in the candidate resource set by a first value, or the adjusting unit 901 reduces a resource selection threshold in the candidate resource set to be infinitesimal.

In some embodiments, a source terminal equipment of the at least one time of transmission of the reserved resource is different from a source terminal equipment of the current transmission.

In some embodiments, a source terminal equipment of the at least one time of transmission of the reserved resource is identical to a source terminal equipment of the current transmission.

In some embodiments, in the case where the source terminal equipment of the at least one time of transmission of the reserved resource is identical to the source terminal equipment of the current transmission, the adjusting unit 901 is further configured to: determine whether the number of bits of the physical sidelink feedback channel exceeds a maximum value that is able to be carried by the physical sidelink feedback channel, and in a case where the destination terminal equipment of the at least one time of transmission of the reserved resource is identical to the destination terminal equipment of the current transmission or a destination terminal equipment in a destination terminal equipment group of the current transmission and the number of bits of the physical sidelink feedback channel exceeds the maximum value that is able to be carried by the physical sidelink feedback channel, lower the priorities of the resources in the candidate resource set.

In some embodiments, the adjusting unit 901 is configured to: determine whether the destination terminal equipment of the at least one time of transmission of the reserved resource is identical to a source terminal equipment of the current transmission, and lower priorities of the resources in the candidate resource set in a case where the destination terminal equipment of the at least one time of transmission of the reserved resource is identical to the source terminal equipment of the current transmission.

In some embodiments, the adjusting unit 901 reduces a resource selection threshold in the candidate resource set by a second value, or the adjusting unit 901 reduces a resource selection threshold in the candidate resource set to be infinitesimal.

In some embodiments, the adjusting unit 901 is configured to: determine whether a source terminal equipment of at least one time of transmission of the reserved resource is identical to a destination terminal equipment of the current transmission or a destination terminal equipment in a destination terminal equipment group of the current transmission, and lower priorities of the resources in the candidate resource set in a case where the source terminal equipment of the at least one time of transmission of the reserved resource is identical to the destination terminal equipment of the current transmission or a destination terminal equipment in the destination terminal equipment group of the current transmission.

In some embodiments, the adjusting unit 901 reduces a resource selection threshold in the candidate resource set by a third value, or the adjusting unit 901 reduces a resource selection threshold in the candidate resource set to be infinitesimal.

In some embodiments, the adjusting unit 901 is configured to: determine whether at least two of the following conditions are satisfied that: a destination terminal equipment of the at least one time of transmission of the reserved resource is identical to a destination terminal equipment of the current transmission or a destination terminal equipment in a destination terminal equipment group of the current transmission, the destination terminal equipment of the at least one time of transmission of the reserved resource is identical to a source terminal equipment of the current transmission, and a source terminal equipment of the at least one time of transmission of the reserved resource is identical to the destination terminal equipment of the current transmission or a destination terminal equipment in a destination terminal equipment group of the current transmission; and when at least two of the above conditions are satisfied, lower the priorities of the resources in the candidate resource set.

In some embodiments, the adjusting unit 901 reduces a resource selection threshold in the candidate resource set by a fourth value, or reduces a resource selection threshold in the candidate resource set to be infinitesimal.

In some embodiments, the current transmission is of an aperiodic service, and a physical sidelink feedback channel resource to which the reserved resource corresponds at least partially overlaps a physical sidelink feedback channel resource to which the aperiodic service corresponds in the time domain, or the current transmission is of a periodical service, and a physical sidelink feedback channel resource to which the reserved resource corresponds at least partially overlaps a physical sidelink feedback channel resource to which an M-th time of transmission of the periodical service corresponds in the time domain, M being a positive integer greater than or equal to 1.

In some embodiments, a size of a resource selection threshold in the candidate resource set is related to the number of reserved resources satisfying the conditions in the candidate resource set, or a size of a resource selection threshold in the candidate resource set is determined at least according to the number of reserved resources satisfying a condition in the candidate resource set.

In some embodiments, in selecting candidate resources, the selecting unit 902 preferentially selects candidate resources from resources that are not reserved, then selects candidate resources from reserved resources not satisfying a condition, and finally selects candidate resources from the reserved resources satisfying the condition.

In some embodiments, the sidelink resource selection apparatus 900 further includes:

a detecting unit 903 configured to detect whether one or more destination terminal equipments in a destination terminal equipment group of the at least one time of transmission of the reserved resource is/are invisible, and the adjusting unit 901 lowers the priorities of the resources in the candidate resource set when the one or more destination terminal equipments in the destination terminal equipment group of the at least one time of transmission of the reserved resources is/are invisible.

In some embodiments, the adjusting unit 901 reduces the resource selection threshold in the candidate resource set by a fifth value.

In some embodiments, the adjusting unit 901 is further configured to: when the one or more destination terminal equipments in the destination terminal equipment group of the at least one time of transmission of the reserved resources is/are visible, determine whether one of the following conditions or a combination thereof is satisfied: a destination terminal equipment of the at least one time of transmission of the reserved resource is identical to the destination terminal equipment of the current transmission or a destination terminal equipment in the destination terminal equipment group of the current transmission, a destination terminal equipment of the at least one time of transmission of the reserved resource is identical to the source terminal equipment of the current transmission, and a source terminal equipment of the at least one time of transmission of the reserved resource is identical to the destination terminal equipment of the current transmission or a destination terminal equipment in the destination terminal equipment group of the current transmission, and lower the priorities of the resources in the candidate resource set when one of the above conditions or a combination thereof is satisfied.

In some embodiments, the adjusting unit 901 reduces the resource selection threshold in the candidate resource set by a sixth value.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the sidelink resource selection apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiments that for a candidate resource set corresponding to a physical sidelink feedback channel, the terminal equipment adjusts a priority of the candidate resource set at least according to a source terminal equipment and/or a destination terminal equipment of a reserved resource contained in the candidate resource set. Thus, not only PSFCH collisions may be alleviated or even avoided, but also unnecessary retransmission may be reduced and reliability of retransmission may be improved.

### Embodiments of the Third Aspect

The embodiments of this disclosure provide a communication system, and reference may be made to FIG. 1, with contents identical to those in the embodiments of the first and second aspect being not going to be described herein any further.

In some embodiments, the communication system 100 may include:

a terminal equipment 102 configured to, for a candidate resource set corresponding to a physical sidelink feedback channel, adjust a priority of the candidate resource set at least according to a source terminal equipment and/or a destination terminal equipment of a reserved resource contained in the candidate resource set; and perform resource selection according to the priority to transmit sidelink data.

The embodiment of this disclosure further provides a network device, which may be, for example, a base station. However, this disclosure is not limited thereto, and it may also be another network device.

FIG. 10 is a schematic diagram of a structure of the network device of the embodiment of this disclosure. As shown in FIG. 10, the network device 1000 may include a processor 1010 (such as a central processing unit (CPU)) and a memory 1020, the memory 1020 being coupled to the processor 1010. The memory 1020 may store various data, and furthermore, it may store a program 1030 for data processing, and execute the program 1030 under control of the processor 1010.

Furthermore, as shown in FIG. 10, the network device 1000 may include a transceiver 1040, and an antenna 1050, etc. Functions of the above components are similar to those in the relevant art, and shall not be described herein any further. It should be noted that the network device 1000 does not necessarily include all the parts shown in FIG. 10, and furthermore, the network device 1000 may include parts not shown in FIG. 10, and the relevant art may be referred to.

The embodiment of this disclosure further provides a terminal equipment; however, this disclosure is not limited thereto, and it may also be another equipment.

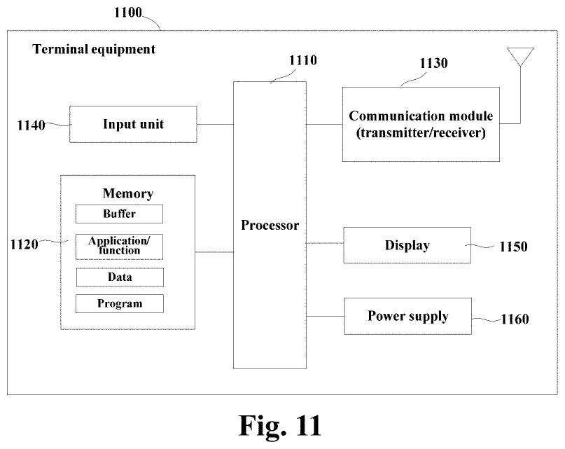

FIG. 11 is a schematic diagram of the terminal equipment of the embodiment of this disclosure. As shown in FIG. 11, the terminal equipment 1100 may include a processor 1110 and a memory 1120, the memory 1120 storing data and a program and being coupled to the processor 1110. It should be noted that this figure is illustrative only, and other types of structures may also be used, so as to supplement or replace this structure and achieve a telecommunications function or other functions.

For example, the processor 1110 may be configured to execute a program to carry out the resource determination method as described in the embodiment of the first aspect. For example, the processor 1110 may be configured to perform the following control: for a candidate resource set corresponding to a physical sidelink feedback channel, adjusting a priority of the candidate resource set by a terminal equipment at least according to a source terminal equipment and/or a destination terminal equipment of a reserved resource contained in the candidate resource set; and performing resource selection by the terminal equipment according to the priority to transmit sidelink data.

As shown in FIG. 11, the terminal equipment 1100 may further include a communication module 1130, an input unit 1140, a display 1150, and a power supply 1160; wherein functions of the above components are similar to those in the relevant art, which shall not be described herein any further. It should be noted that the terminal equipment 1100 does not necessarily include all the parts shown in FIG. 11, and the above components are not necessary. Furthermore, the terminal equipment 1100 may include parts not shown in FIG. 11, and the relevant art may be referred to.

An embodiment of this disclosure provides a computer readable program code, which, when executed in a terminal equipment, will cause the terminal equipment to carry out the sidelink resource selection method as described in the embodiment of the first aspect.

An embodiment of this disclosure provides a computer readable medium, including a computer readable program code, which will cause a terminal equipment to carry out the sidelink resource selection method as described in the embodiment of the first aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

Supplement 1. A sidelink resource selection method, including:

for a candidate resource set corresponding to a physical sidelink feedback channel, adjusting a priority of the candidate resource set by a terminal equipment at least according to a source terminal equipment and/or a destination terminal equipment of a reserved resource contained in the candidate resource set; and

performing resource selection by the terminal equipment according to the priority to transmit sidelink data.

Supplement 2. The method according to supplement 1, wherein a service type of at least one time of transmission to which the reserved resource corresponds is of a unicast service or a groupcast service, and feedback of the at least one time of transmission is enabled.

Supplement 3. The method according to supplement 1 or 2, wherein a priority of the at least one of transmission of the reserved resource is lower than a priority of current transmission.

Supplement 4. The method according to any one of supplements 1-3, wherein,

the reserved resource is a resource detected by the terminal equipment and indicated by other terminal equipments to be reserved via sidelink control information.

Supplement 5. The method according to any one of supplements 1-4, wherein the adjusting a priority of the candidate resource set by a terminal equipment at least according to a source terminal equipment and/or a destination terminal equipment of a reserved resource contained in the candidate resource set includes:

determining whether a destination terminal equipment of at least one time of transmission of the reserved resource is identical to a destination terminal equipment of the current transmission or a destination terminal equipment in a destination terminal equipment group of the current transmission; and

lowering priorities of the resources in the candidate resource set in a case where the destination terminal equipment of the at least one time of transmission of the reserved resource is identical to the destination terminal equipment of the current transmission or a destination terminal equipment in the destination terminal equipment group of the current transmission.

Supplement 6. The method according to supplement 5, wherein the lowering priorities of the resources in the candidate resource set includes:

reducing a resource selection threshold in the candidate resource set by a first value.

Supplement 7. The method according to supplement 6, wherein the resource selection threshold is a reference signal received power (RSRP) value of a last transmitted physical sidelink control channel (PSCCH) or a physical sidelink shared channel (PSSCH) reserved for the reserved resource in the candidate resource set.

Supplement 8. The method according to supplement 5, wherein a source terminal equipment of the at least one time of transmission of the reserved resource is different from a source terminal equipment of the current transmission.

Supplement 9. The method according to supplement 5, wherein a source terminal equipment of the at least one time of transmission of the reserved resource is identical to a source terminal equipment of the current transmission.

Supplement 10. The method according to supplement 9, wherein the method further includes:

determining whether the number of bits of the physical sidelink feedback channel exceeds a maximum value that is able to be carried by the physical sidelink feedback channel; and

in a case where the destination terminal equipment of the at least one time of transmission of the reserved resource is identical to the destination terminal equipment of the current transmission or a destination terminal equipment in a destination terminal equipment group of the current transmission and the number of bits of the physical sidelink feedback channel exceeds the maximum value that is able to be carried by the physical sidelink feedback channel, lowering the priorities of the resources in the candidate resource set.

Supplement 11. The method according to supplement 10, wherein the lowering the priorities of the resources in the candidate resource set includes:

reducing a resource selection threshold in the candidate resource set by a first value.

Supplement 12. The method according to any one of supplements 1-4, wherein the adjusting a priority of the candidate resource set by a terminal equipment according to a source terminal equipment and/or a destination terminal equipment of a reserved resource contained in the candidate resource set includes:

determining whether a destination terminal equipment of at least one time of transmission of the reserved resource is identical to a source terminal equipment of the current transmission; and

lowering priorities of the resources in the candidate resource set in a case where the destination terminal equipment of the at least one time of transmission of the reserved resource is identical to the source terminal equipment of the current transmission.

Supplement 13. The method according to supplement 12, wherein the lowering priorities of the resources in the candidate resource set includes:

reducing a resource selection threshold in the candidate resource set by a second value.

Supplement 14. The method according to supplement 13, wherein the resource selection threshold is a reference signal received power (RSRP) value of a last transmitted physical sidelink control channel (PSCCH) or a physical sidelink shared channel (PSSCH) reserved for the reserved resource in the candidate resource set.

Supplement 15. The method according to any one of supplements 1-4, wherein the adjusting a priority of the candidate resource set by a terminal equipment according to a source terminal equipment and/or a destination terminal equipment of a reserved resource contained in the candidate resource set includes:

determining whether a source terminal equipment of at least one time of transmission of the reserved resource is identical to a destination terminal equipment of the current transmission or a destination terminal equipment in a destination terminal equipment group of the current transmission; and

lowering priorities of the resources in the candidate resource set in a case where the source terminal equipment of the at least one time of transmission of the reserved resource is identical to the destination terminal equipment of the current transmission or a destination terminal equipment in the destination terminal equipment group of the current transmission.

Supplement 16. The method according to supplement 15, wherein the lowering priorities of the resources in the candidate resource set includes:

reducing a resource selection threshold in the candidate resource set by a third value.

Supplement 17. The method according to supplement 16, wherein the resource selection threshold is a reference signal received power (RSRP) value of a last transmitted physical sidelink control channel (PSCCH) or a physical sidelink shared channel (PSSCH) reserved for the reserved resource in the candidate resource set.

Supplement 18. The method according to any one of supplements 1-4, wherein the adjusting a priority of the candidate resource set by a terminal equipment according to a source terminal equipment and/or a destination terminal equipment of a reserved resource contained in the candidate resource set includes:

determining whether at least two of the following conditions are satisfied that: a destination terminal equipment of the at least one time of transmission of the reserved resource is identical to a destination terminal equipment of the current transmission or a destination terminal equipment in a destination terminal equipment group of the current transmission, the destination terminal equipment of the at least one time of transmission of the reserved resource is identical to a source terminal equipment of the current transmission, and a source terminal equipment of the at least one time of transmission of the reserved resource is identical to the destination terminal equipment of the current transmission or a destination terminal equipment in a destination terminal equipment group of the current transmission; and

when at least two of the above conditions are satisfied, lowering priorities of the resources in the candidate resource set.

Supplement 19. The method according to supplement 18, wherein the lowering priorities of the resources in the candidate resource set includes:

reducing a resource selection threshold in the candidate resource set by a fourth value.

Supplement 20. The method according to any one of supplements 1-19, wherein the current transmission is of an aperiodic service, and a physical sidelink feedback channel resource to which the reserved resource corresponds at least partially overlaps a physical sidelink feedback channel resource to which the aperiodic service corresponds in the time domain, or

the current transmission is of a periodical service, and a physical sidelink feedback channel resource to which the reserved resource corresponds at least partially overlaps a physical sidelink feedback channel resource to which an M-th time of transmission of the periodical service corresponds in the time domain, M being a positive integer greater than or equal to 1.

Supplement 21. The method according to supplement 5, 10, 12, 15 or 18, wherein the lowering priorities of the resources in the candidate resource set includes:

reducing a resource selection threshold in the candidate resource set to be infinitesimal.

Supplement 22. The method according to supplement 21, wherein the resource selection threshold is a reference signal received power (RSRP) value of a last transmitted physical sidelink control channel (PSCCH) or a physical sidelink shared channel (PSSCH) reserved for the reserved resource in the candidate resource set.

Supplement 23. The method according to any one of supplements 1-22, wherein the method further includes:

when the terminal equipment selects candidate resources, preferentially selecting resources from unreserved resources, then selecting resources from reserved resources unsatisfying the conditions, and finally selecting resources from reserved resources satisfying the conditions.

Supplement 24. The method according to any one of supplements 1-4, wherein the method further includes:

detecting by the terminal equipment whether the destination terminal equipment in the destination terminal equipment group of the at least one time of transmission of the reserved resources is invisible, or the terminal equipment is not sure whether the destination terminal equipment in the destination terminal equipment group of the at least one time of transmission of the reserved resources is visible; and

lowering the priorities of the resources in the candidate resource set in a case where the destination terminal equipment in the destination terminal equipment group of the at least one time of transmission of the reserved resources is invisible or whether is it visible is not sure.

Supplement 25. The method according to supplement 24, wherein the lowering priorities of the resources in the candidate resource set includes:

reducing a resource selection threshold in the candidate resource set by a fifth value.

Supplement 26. The method according to supplement 24, wherein the adjusting a priority of the candidate resource set by a terminal equipment according to a source terminal equipment and/or a destination terminal equipment of a reserved resource contained in the candidate resource set includes:

when the one or more destination terminal equipments in the destination terminal equipment group of the at least one time of transmission of the reserved resources is/are visible, determining whether one of the following conditions or a combination thereof is satisfied: a destination terminal equipment of the at least one time of transmission of the reserved resource is identical to the destination terminal equipment of the current transmission or a destination terminal equipment in the destination terminal equipment group of the current transmission, a destination terminal equipment of the at least one time of transmission of the reserved resource is identical to the source terminal equipment of the current transmission, and a source terminal equipment of the at least one time of transmission of the reserved resource is identical to the destination terminal equipment of the current transmission or a destination terminal equipment in the destination terminal equipment group of the current transmission; and

lowering priorities of the resources in the candidate resource set when one of the conditions or a combination thereof is satisfied.

Supplement 27. The method according to supplement 26, wherein the lowering priorities of the resources in the candidate resource set includes:

reducing a resource selection threshold in the candidate resource set by a sixth value.

Supplement 28. The method according to supplement 25 or 27, wherein the resource selection threshold is a reference signal received power (RSRP) value of a last transmitted physical sidelink control channel (PSCCH) or a physical sidelink shared channel (PSSCH) reserved for the reserved resource in the candidate resource set.

Supplement 29. The method according to any one of supplements 6-28, wherein a size of the resource selection threshold is related to the number of reserved resources satisfying a condition in the candidate resource set, or a size of the resource selection threshold is determined at least according to the number of reserved resources satisfying a condition in the candidate resource set.

Supplement 30. The method according to supplement 29, the resource selection threshold includes any one of the first to sixth values, and any two of the first to sixth values are different from each other, or at least two of the first to sixth values are identical.

Supplement 31. A terminal equipment, including a memory and a processor, the memory storing a computer program, and the processor being configured to execute the computer program to carry out the sidelink resource selection method as described in any one of supplements 1-30.

What is claimed is:

1. A sidelink resource selection apparatus, comprising:
an adjusting unit configured to, for a candidate resource set corresponding to a physical sidelink feedback channel, adjust a resource selection threshold of the candidate resource set at least according to a source terminal equipment and/or a destination terminal equipment of a reserved resource contained in the candidate resource set; and
a selecting unit configured to perform resource selection according to the resource selection threshold to transmit sidelink data.

2. The apparatus according to claim 1, wherein a service type of at least one time of transmission to which the reserved resource corresponds is of a unicast service or a groupcast service, and feedback of the at least one time of transmission is enabled; and/or
a priority of the at least one of transmission of the reserved resource is lower than a priority of current transmission.

3. The apparatus according to claim 1, wherein the reserved resource is a resource detected by a terminal equipment and indicated by other terminal equipments to be reserved via sidelink control information.

4. The apparatus according to claim 1, wherein the adjusting unit is configured to:
determine whether a destination terminal equipment of at least one time of transmission of the reserved resource is identical to a destination terminal equipment of the current transmission or a destination terminal equipment in a destination terminal equipment group of the current transmission, and
adjust resource selection thresholds of the resources in the candidate resource set in a case where the destination terminal equipment of the at least one time of transmission of the reserved resource is identical to the destination terminal equipment of the current transmission or a destination terminal equipment in the destination terminal equipment group of the current transmission.

5. The apparatus according to claim 4, wherein the adjusting resource selection thresholds of the resources in the candidate resource set by the adjusting unit comprises: reducing a resource selection threshold in the candidate resource set by a first value, or reducing a resource selection threshold in the candidate resource set to be infinitesimal.

6. The apparatus according to claim 4, wherein a source terminal equipment of the at least one time of transmission of the reserved resource is different from a source terminal equipment of the current transmission, or
a source terminal equipment of the at least one time of transmission of the reserved resource is identical to a source terminal equipment of the current transmission.

7. The apparatus according to claim 6, wherein in the case where the source terminal equipment of the at least one time of transmission of the reserved resource is identical to the source terminal equipment of the current transmission, the adjusting unit is further configured to:
determine whether the number of bits of the physical sidelink feedback channel exceeds a maximum value that is able to be carried by the physical sidelink feedback channel, and
in a case where the destination terminal equipment of the at least one time of transmission of the reserved resource is identical to the destination terminal equipment of the current transmission or a destination terminal equipment in a destination terminal equipment group of the current transmission and the number of bits of the physical sidelink feedback channel exceeds the maximum value that is able to be carried by the physical sidelink feedback channel, adjust resource selection thresholds of the resources in the candidate resource set.

8. The apparatus according to claim 6, wherein the adjusting resource selection thresholds of the resources in the candidate resource set by the adjusting unit comprises: reducing a resource selection threshold in the candidate resource set by a first value, or reducing a resource selection threshold in the candidate resource set to be infinitesimal.

9. The apparatus according to claim 1, wherein the adjusting unit is configured to:
determine whether a destination terminal equipment of at least one time of transmission of the reserved resource is identical to a source terminal equipment of the current transmission, and
adjust resource selection thresholds of the resources in the candidate resource set in a case where the destination terminal equipment of the at least one time of transmission of the reserved resource is identical to the source terminal equipment of the current transmission.

10. The apparatus according to claim 9, wherein the adjusting resource selection thresholds of the resources in the candidate resource set by the adjusting unit comprises: reducing a resource selection threshold in the candidate resource set by a second value, or reducing a resource selection threshold in the candidate resource set to be infinitesimal.

11. The apparatus according to claim 1, wherein the adjusting unit is configured to:
determine whether a source terminal equipment of at least one time of transmission of the reserved resource is identical to a destination terminal equipment of the current transmission or a destination terminal equipment in a destination terminal equipment group of the current transmission, and
adjust resource selection thresholds of the resources in the candidate resource set in a case where the source terminal equipment of the at least one time of transmission of the reserved resource is identical to the destination terminal equipment of the current transmission or a destination terminal equipment in the destination terminal equipment group.

12. The apparatus according to claim 11, wherein the adjusting resource selection thresholds of the resources in the candidate resource set by the adjusting unit comprises: reducing a resource selection threshold in the candidate resource set by a third value, or reducing a resource selection threshold in the candidate resource set to be infinitesimal.

13. The apparatus according to claim 1, wherein the adjusting unit is configured to:
determine whether at least two of the following conditions are satisfied that: a destination terminal equipment of the at least one time of transmission of the reserved resource is identical to a destination terminal equipment of the current transmission or a destination terminal equipment in a destination terminal equipment group of the current transmission, the destination terminal equipment of the at least one time of transmission of the reserved resource is identical to a source terminal equipment of the current transmission, and a source terminal equipment of the at least one time of transmission of the reserved resource is identical to the destination terminal equipment of the current transmission or a destination terminal equipment in a destination terminal equipment group of the current transmission;
and when at least two of the above conditions are satisfied, reduce a resource selection threshold in the candidate resource set by a fourth value, or reduce a resource selection threshold in the candidate resource set to be infinitesimal.

14. The apparatus according to claim 1, wherein the current transmission is of an aperiodic service, and a physical sidelink feedback channel resource to which the reserved resource corresponds at least partially overlaps a physical sidelink feedback channel resource to which the aperiodic service corresponds in the time domain, or
the current transmission is of a periodical service, and a physical sidelink feedback channel resource to which the reserved resource corresponds at least partially overlaps a physical sidelink feedback channel resource to which an M-th time of transmission of the periodical service corresponds in the time domain, M being a positive integer greater than or equal to 1.

15. The apparatus according to claim 1, wherein a size of a resource selection threshold in the candidate resource set is determined at least according to the number of reserved resources satisfying a condition in the candidate resource set.

16. The apparatus according to claim 1, wherein, in selecting candidate resources, the selecting unit preferentially selects candidate resources from resources that are not reserved, then selects candidate resources from reserved resources not satisfying a condition, and finally selects candidate resources from the reserved resources satisfying the condition.

17. The apparatus according to claim 1, wherein the apparatus further comprises:
a detecting unit configured to detect whether one or more destination terminal equipments in a destination terminal equipment group of the at least one time of transmission of the reserved resource is/are invisible,
and the adjusting unit is configured to reduce the resource selection threshold in the candidate resource set by a fifth value when the one or more destination terminal equipments in the destination terminal equipment group of the at least one time of transmission of the reserved resources is/are invisible.

18. The apparatus according to claim 17, wherein the adjusting unit is further configured to:
when the one or more destination terminal equipments in the destination terminal equipment group of the at least one time of transmission of the reserved resources is/are invisible, determine whether one of the following conditions or a combination thereof is satisfied: a destination terminal equipment of the at least one time of transmission of the reserved resource is identical to the destination terminal equipment of the current transmission or a destination terminal equipment in the destination terminal equipment group of the current transmission, a destination terminal equipment of the at least one time of transmission of the reserved resource is identical to the source terminal equipment of the current transmission, and a source terminal equipment of the at least one time of transmission of the reserved resource is identical to the destination terminal equipment of the current transmission or a destination terminal equipment in the destination terminal equipment group of the current transmission,
and reduce the resource selection threshold in the candidate resource set by a sixth value when one of the above conditions or a combination thereof is satisfied.

19. A sidelink resource selection method, comprising:
for a candidate resource set corresponding to a physical sidelink feedback channel, adjusting a resource selection threshold of the candidate resource set by a terminal equipment at least according to a source terminal equipment and/or a destination terminal equipment of a reserved resource contained in the candidate resource set; and
performing resource selection by the terminal equipment according to the resource selection threshold to transmit sidelink data.

20. A communication system, comprising:
a terminal equipment configured to, for a candidate resource set corresponding to a physical sidelink feedback channel, adjust a resource selection threshold of the candidate resource set at least according to a source terminal equipment and/or a destination terminal equipment of a reserved resource contained in the candidate resource set, and perform resource selection according to the resource selection threshold to transmit sidelink data.
